(19) United States
(12) Patent Application Publication
(10) Pub. No.: US 2003/0083175 A1
(43) Pub. Date: May 1, 2003

(54) Full toroidal continuously variable unit with a high caster angle

(76) Inventors: Raymond James Haka, Brighton, MI (US); Hamid Vahabzadeh, Oakland, MI (US)

Correspondence Address: LESLIE C. HODGES, General Motors Corporation, Mail code 482-C23-B21, P.O. Box 300, Detroit, MI, 48265-3000, US

(21) Appl. No.: 10/016,212

(22) Filed: Oct. 30, 2001

(51) Int. Cl. F16H 15/38

(52) U.S. Cl. 476/40

(57) ABSTRACT

A full toroidal continuously variable unit (CVU) has a caster angle control and a trunnion position control that permits the caster angle to be greater than 60 degrees, which is the angle of critical damping for the torus and traction roller assembly of the CVU. The trunnion position control and the caster angle control are connected with the roller through a spherical bearing. The trunnion position control acts on the ball portion of the bearing and the caster angle control acts on the housing portion of the bearing. The traction roller is rotatably mounted on the housing of the bearing. The trunnion position control is grounded through a central member such that the axial and radial components imposed thereon are grounded and not transferred to the traction roller or the caster angle control. The caster angle control includes a linkage that maintains a constant angular orientation of the axis of the roller tilt at all roller positions.

### TECHNICAL FIELD

This invention relates to continuously variable units in which the transfer rollers have a caster angle relative to the power transfer discs.

### BACKGROUND OF THE INVENTION

Toroidal type continuously variable units (CVU) are either full toroidal or half toroidal mechanisms. The full toroidal CVUs include two half toroidal members (input and output) or discs and a plurality of transfer rollers that transfer the speed and torque between the two half toroidal members. The rollers are rotatably mounted on a roller trunnion and are effective to control the transmission ratio between the input disc and the output disc of the CVU. The roller trunnion moves the transfer rollers relative to the input and output discs to effect a ratio change in the CVU. The roller trunnion is mounted at a caster angle of approximately 20 degrees relative to one of the half toroidal discs. This is the maximum caster angle permitted by the outer diameter of the toroidal members in a full toroidal CVU described in the prior art. The caster angle imposes steer forces on the rollers as they are moved transversely to the rotary axis of the torus.

The roller trunnion has a hydraulic piston the moves it relative to the circumferences of the toroidal halves. The caster angle steer mechanism causes the roller to move circumferentially as a function of the CVU ratio. The roller position change causes the hydraulic piston apply force to change the angle of attack relative to the torus. As the roller trunnion is forced to move relative to the toroidal halves, a radial force component and an axial force component are imposed on the rollers when it is off its neutral plane. The radial component urges the roller away from the center of the torus, thereby creating a loss mechanism and reduced efficiency. The axial force will cause a slight variation in the coefficient of traction between the right and left contact patches between the roller and each disc.

### SUMMARY OF THE INVENTION

It is an object of the present invention to provide an improved full toroidal, continuously variable unit having a roller trunnion caster angle greater than 60 degrees.

In one aspect of the present invention, the line of action of a traction roller trunnion reaction torque and the line of action of the caster angle mechanism are separated. In another aspect of the present invention, the traction roller trunnion reaction torque is transmitted to the traction rollers through a sphere portion of a spherical bearing which is reacted to a ground element external to the torus. In yet another aspect of the present invention, a caster angle control element is connected with the housing portion of the spherical bearing. In still another aspect of the present invention, the caster angle control element and the roller trunnion are components of a four bar linkage.

In yet still another aspect of the present invention, the caster angle is equal to or greater than the angle necessary to establish critical damping of the traction rollers. In a further aspect of the present invention, the CVU has three traction roller trunnion controls that are individually actuated in unison by hydraulic pistons. In a yet further aspect of the present invention, each of the trunnion controls is rotatably mounted on a central shaft and each trunnion control has a rim portion that is driven arcuately about the CVU discs by hydraulic pistons to effect a change of ratio within the CVU. In a still further aspect of the present invention, the pistons are bi-directionally active. In a yet still further aspect of the present invention, a trunnion control mechanism is provided to employ a caster angle on the traction rollers in the range of 25 to 89 degrees.

### BRIEF DESCRIPTION OF THE DRAWINGS

FIG. 1 is a schematic representation of a powertrain having a power transmission incorporating the present invention.

FIG. 2 is an elevational view of a trunnion control mechanism in a CVT incorporating the present invention.

FIG. 3 is a top view of the mechanism shown in FIG. 1.

FIG. 4 is a side view of the mechanism shown in FIGS. 1 and 2.

FIG. 5 is an alternative structure of the mechanism as shown in FIG. 4.

FIG. 6 is a view of a portion of a hydraulic mechanism employed with the mechanism of FIG. 1.

FIG. 7 is an alternative structure of the mechanism shown in FIG. 6.

FIG. 8 is another alternative structure of the mechanism shown in FIG. 6.

FIG. 9 is a schematic representation of a portion of a trunnion control mechanism shown in FIG. 2 and employing the structures depicted in FIGS. 6 through 8.

FIG. 10 is a further alternative structure of the hydraulic mechanism depicted in FIG. 6.

FIG. 11 is a schematic representation of a portion of another trunnion control mechanism employed with the trunnion control of FIG. 2.

FIG. 12 is an alternative embodiment of a trunnion control mechanism incorporating the present invention.

FIG. 13 is a partial side view of the trunnion control mechanism shown in FIG. 12.

### DESCRIPTION OF THE PREFERRED EMBODIMENT

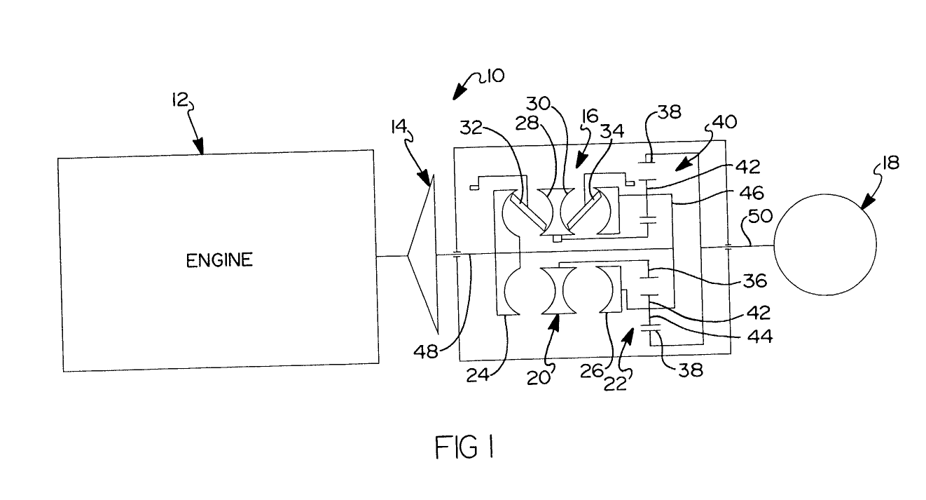

A powertrain 10, FIG. 1, includes a conventional internal combustion engine 12, a conventional vibration damper 14, a continuously variable transmission (CVT) 16 and a conventional final drive gearing 18. The CVT 14 has a full toroidal continuously variable unit (CVU) 20 and a planetary gear arrangement 22. The CVU has two input members 24, 26 and two output members 28, 30. The output members 28, 30 are joined in a single component. The input members 24 and 26 are disposed in a traction drive arrangement with respective output members 28 and 30 through respective traction rollers 32 and 34. There are three traction rollers 32 and three traction rollers 34 that are equiangularly spaced between the respective input members 24, 26 and output members 28, 30; however, only one each is shown in FIG. 1. Those skilled in the art will be familiar with these structures.

The planetary gear set 22 includes a sun gear member 36, a ring gear member 38, and a planet carrier assembly member 40 that has pairs of intermeshing planet pinion gear members 42 and 44 rotatably mounted on a planet carrier 46. The planet pinion gear members 42 and 44 mesh with the sun gear member 36 and the ring gear member 38. The sun gear member 36 is continuously connected with the output members 28, 30. The input member 24 is continuously connected with an input shaft 48 that is continuously connected with the engine 12 via the damper 14. The input shaft 48 is also continuously connected with the planet carrier assembly member 40 which is also continuously connected with the input member 26. The ring gear member 38 is continuously connected with an output shaft 50 that is drivingly connected with the final drive gearing 18. The ring gear member 38 and the planet carrier assembly member 40 can be connected to further planetary gear members to provide additional gear ratios between the planetary gear set 22 and the output shaft 50 as desired. Such gearing arrangements are well known.

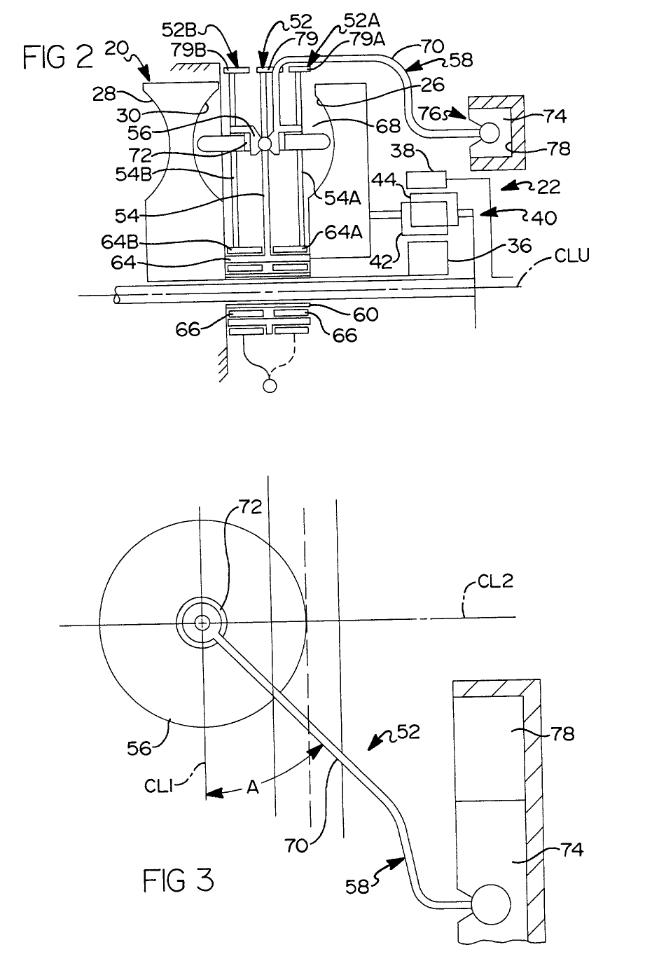

Each of the equiangularly-spaced traction rollers 32 and 34 is mounted on a traction roller control trunnion assemblies 52 that include a radial support member 54, 54A, and 54B, a spherical bearing 56, and a caster angle control mechanism 58. As seen in FIGS. 2, 3, and 4, the radial supports 54 are supported on a sleeve 60 that is grounded through a stationary housing 62 and hubs 64. As an alternative, the hubs 64, 64A, and 64B can be supported by roller bearings on a shaft 65 that connects the output members 26, 28 with the sun gear member 36.

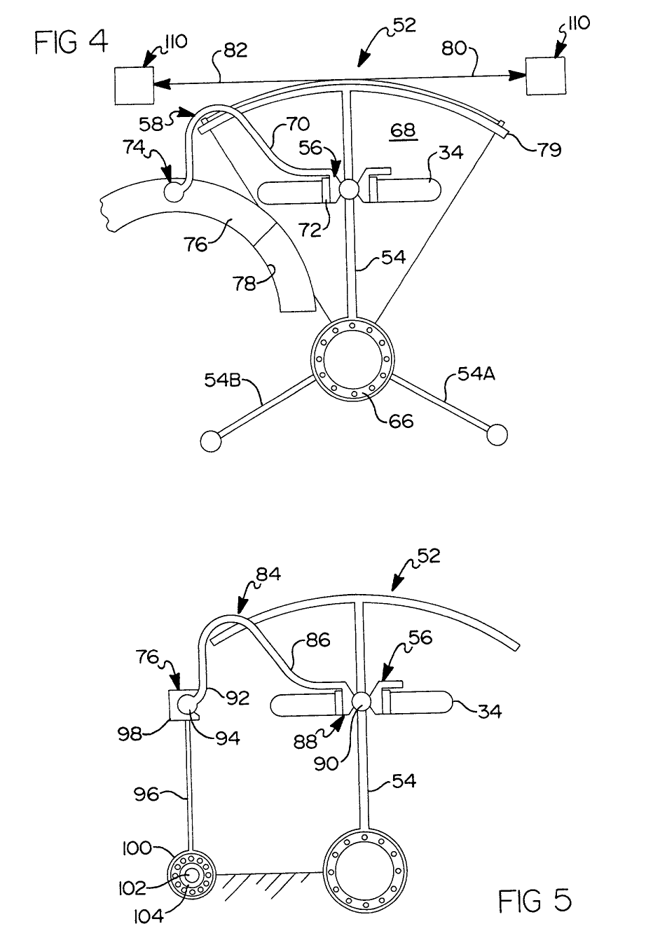

In the embodiment shown, each of the hubs 64A and 64B of the support members 54A and 54B, respectively, is rotatably supported on the hub 64. The radial supports 54, 54A and 54B, as seen in FIG. 4, are spaced equiangularly within a torus or roller cavity 68 between the input member 26 and the output member 34. The roller bearings 66 are effective, due to the tolerances between the inner and outer races, to accommodate minor alignment errors between the radial position of the spherical joint of the bearing 56 and the center of the cavity 68.

Each caster angle control mechanism 58 has a rod member 70 integral with or otherwise secured to the spherical bearing 56. The roller 34 is supported on the rod member 70 through a roller bearing 72. The rod member 70 has a cam follower 74 supported thereon through a ball and socket arrangement 76. The cam follower 74 is slidably supported in a circular cam cavity 78 as best seen in FIG. 4. The angle A between the rod 70 and the centerline CL1 of the traction roller 34 of the CVU 20 is the caster angle. The centerline CL1 is positioned within a central plane of the torus cavity 68. The rollers 34 will steer as they are displaced from the centerline CL2 of traction roller 34 of the CVU 20. The caster angle A dampens the angular motion of the rollers 34 to prevent speed ratio oscillations and thereby reduce hunting of the rollers 34 relative the torus members. When the angle A is approximately 60 degrees or larger, critical damping is present and hunting is eliminated.

Each radial support 54, 54A, 54B has an arcuate shoe 79 to which is attached a pair of control strap members 80 and 82 that are operable to establish the circumferential position of the radial supports 54, 54A, 54B relative to the roller cavity 68. Each control member 80, 82 is positioned by hydraulic control assemblies that will be described later. When the control member 80 has a force applied thereto, the radial support 54 will pivot clockwise as seen in FIG. 4. The caster angle control mechanism 58 will cause the traction roller 34 to pivot on the spherical bearing 56 relative to the input member 26 and the output member 30, thereby changing the drive ratio therebetween. Due to the caster angle established by the rod members 70, the rollers steer to the proper ratio as established by the amount of circumferential displacement of the radial supports 54. With the present invention, the caster angle can be maintained at a value greater than the critical damping angle which prevents hunting of the traction rollers 34. When the control member 82 has an unbalancing force applied thereto, the radial supports 54 will pivot in the counterclockwise direction, as seen in FIG. 4, to have the opposite effect on the traction rollers 34. The radial support 54, rod member 70, and the cam 78 cooperate to form a four bar linkage in which the ball and socket 76 and the housing of the spherical bearing 56 maintain an angular orientation which causes the traction rollers 34 to pivot or steer within the cavity 68.

In FIG. 2, the traction rollers 34 are shown in a one-to-one ratio. If the traction rollers 34 are pivoted clockwise, the ratio between the input member 26 and the output member 30 will be an underdrive ratio. If the traction rollers 34 are pivoted counterclockwise, the ratio will be an overdrive ratio. The movement of the radial supports 54 and the caster angle control 58 will cause the traction rollers to steer to the proper angle to effect the desired ratio. As mentioned above, due to the high caster angle in excess of 60, the rollers 34 are damped to prevent oscillations or “hunting” relative to the input member 26 and the output member 30.

An alternative caster angle control mechanism 84 is shown in FIG. 5. The control mechanism 84 includes a rod member 86 that has one end 88 secured with a housing 90 of the spherical bearing 56 and the other end 92 formed with a ball 94 which is a component of the ball and socket 76. An arm 96 is secured with the socket 98 of the ball and socket 76 and includes a hub 100 that is rotatably supported on a stationary shaft or pin 102 by a roller bearing 104. The arm 96, rod member 86 and the radial support 54 cooperate to form a four bar linkage that maintains the proper angular displacement of the traction roller 34 within the roller cavity 68.

The caster angle control mechanisms 58 and 84 eliminate the axial and radial components of force that are inherent in the prior art mechanisms wherein the traction roller position control and the caster angle control act on the same axis and the forces imposed on the traction roller are grounded through the roller bearing 72. It will be appreciated by those skilled in the art that the traction position control forces are grounded at the sleeve 60. The spherical bearing 56 permits the rollers 32 and 34 to seek the proper angle needed by the CVU 20 to establish the desired ratio. Also, it should be noted that the line of action of the forces imposed by the trunnion position control forces act in a plane passing through the center of the traction rollers 34 and 32 that is perpendicular to the centerline CLU of the CVU 20 and do not affect the caster angle alignment. The spherical bearing 56 is also instrumental in separating the traction roller forces from the trunnion position control forces.

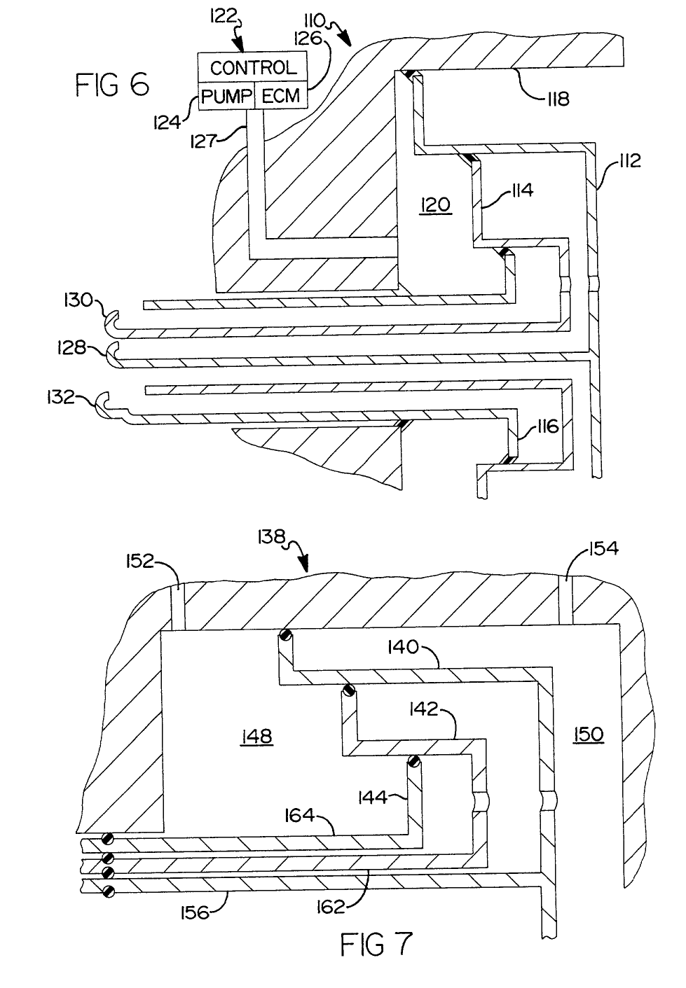

An electro-hydraulic control 110 is shown in FIG. 6. The electro-hydraulic control 110 includes three annular pistons 112, 114, and 116 that are disposed in nested arrangement in a cavity 118. The piston 112 and the cavity 118 cooperate to form a chamber 120 that is in fluid communication with a conventional electro-hydraulic control module 122 that includes a conventional hydraulic source (pump) 124 and a conventional electronic control module (ECM) 126 which includes a conventional programmable digital computer. The control module 122 is connected with the chamber through a passage 127. The control module 122 receives signals or commands from various vehicle operating parameters and operator controls that include input and output speed sensors, throttle control, engine torque, pressures in the control system and ratio desired to name a few. The electro-hydraulic control module 122 issues pressure commands to the chamber 120 in response to the signals or commands.

The piston 112 has a rod portion 128 that is connected with the control member 80 on the trunnion assembly 52. The piston 114 has a sleeve extension 130 that is connected with a similar control member associated with the trunnion assembly 52A, and the piston 116 has a sleeve extension 132 that is connected with a similar control member associated with the trunnion assembly 52B. Each piston 112, 114 and 116 has the same annular area presented to the chamber 120. Therefore, the force on each of the pistons 112, 114 and 116 is the same, which results in the same force being applied to each of the control members 80. A substantially identical piston and cavity arrangement is provided to establish control forces for the control member 82. By changing the pressure level in the chamber 120 for one of the piston and cavity assemblies, the angular orientation of the trunnion assembly 52 can be altered to effect a ratio change in the CVU 20. The cavity 118 surrounding the piston 112 opposite the cavity 120 is open to a hydraulic sump or reservoir, not shown, to prevent pressure build-up on the back side thereof. The pistons 114 and 112 have respective passages 134 and 136 that vent the back side of the pistons 116 and 114 to the sump.

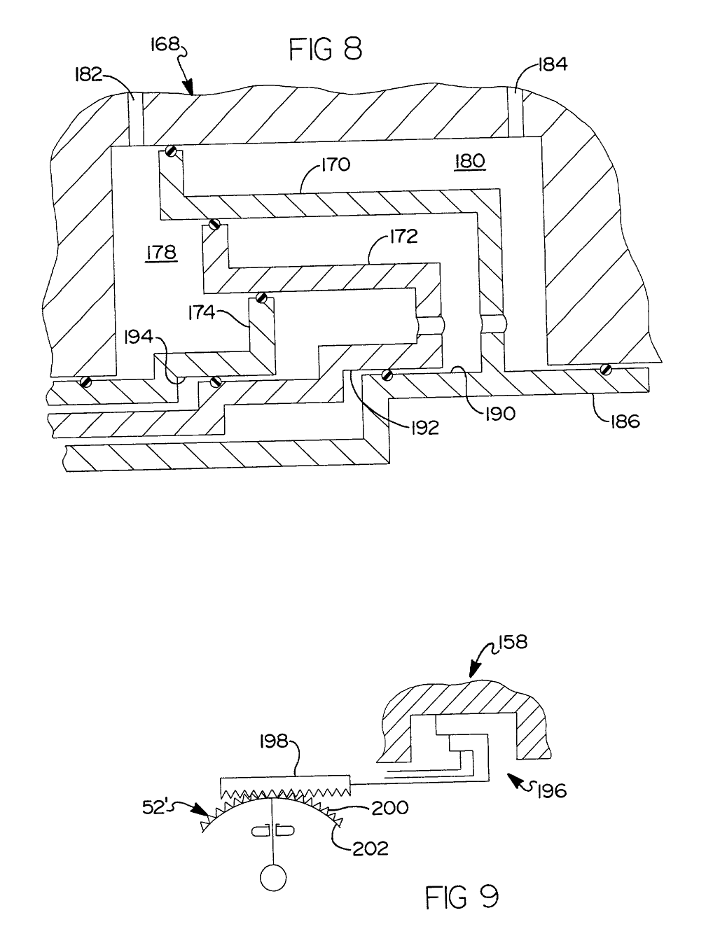

A push-pull piston assembly 138 that can be used with trunnion control mechanism such as those shown in FIGS. 9 and 11 which will be described later. The assembly 138 includes three nested annular pistons 140, 142 and 144 that are slidably disposed in a closed cavity 146 and cooperate therewith to form two chambers 148 and 150. The chamber 148 is connected with the control 122 via a passage 152, and the chamber 150 communicates with the control 122 via a passage 154. The piston 140 has an output member 156 that connects with a trunnion control mechanism such as 158, shown in FIG. 9, or 160, shown in FIG. 11. The pistons 142 and 144 have respective output members 162, 164 that are connected with respective trunnion control mechanisms. The pistons 140 and 142 have respective passages formed therein to communicate the right side of the pistons 142 and 144, respectively, with the chamber 150. Hydraulic pressure in the chamber 148 will urge the pistons 140, 142 and 144 rightward while pressure in the chamber 150 will urge the pistons 140, 142 and 144 leftward. Since the output members 156, 162 and 164 reduce the area of the left side of the pistons 140, 142 and 144, there will be a slight difference in the right-to-left effective area of pistons 140, 142 and 144.

Shown in FIG. 8 is an alternative push-pull piston assembly 168 that includes three nested pistons 170, 172 and 174 slidably disposed in a sealed cavity 176 to form two hydraulic chambers 178, 180 that are connected with the control 122 via respective passages 182, 184. The piston 170 has a hub 186 extending rightward therefrom and being slidably supported in an opening 188 in the cavity 176. A hub and output member 190, having an outer diameter equal to the outer diameter of the hub 186, extends leftward from the piston 170. The output member 190 slidably supports a hub and output member 192 of the piston 172. The piston 174 has a hub and output member 194 that is slidably supported on the hub and output member 192 of the piston 172. This arrangement permits the areas on both sides of the pistons 170, 172 and 174 to be equal, which improves the load sharing of the three rollers.

The schematic representation of the trunnion control mechanism 158, shown in FIG. 9, includes a push-pull piston assembly 196 that may be constructed in accordance with those shown in FIGS. 7, 8 or 10 or any conventional double-acting piston assembly. The output of each piston is connected with a rack gear member 198 that meshes with a sector gear member 200 formed on an outer periphery 202 of a trunnion assembly 52′. When a pressure unbalance is present at the piston assembly 196, the rack gear member 198 will move linearly to enforce rotary movement of the sector gear member 200 and therefore the trunnion assembly 52′ resulting in a change of drive ratio in the CVU 20.

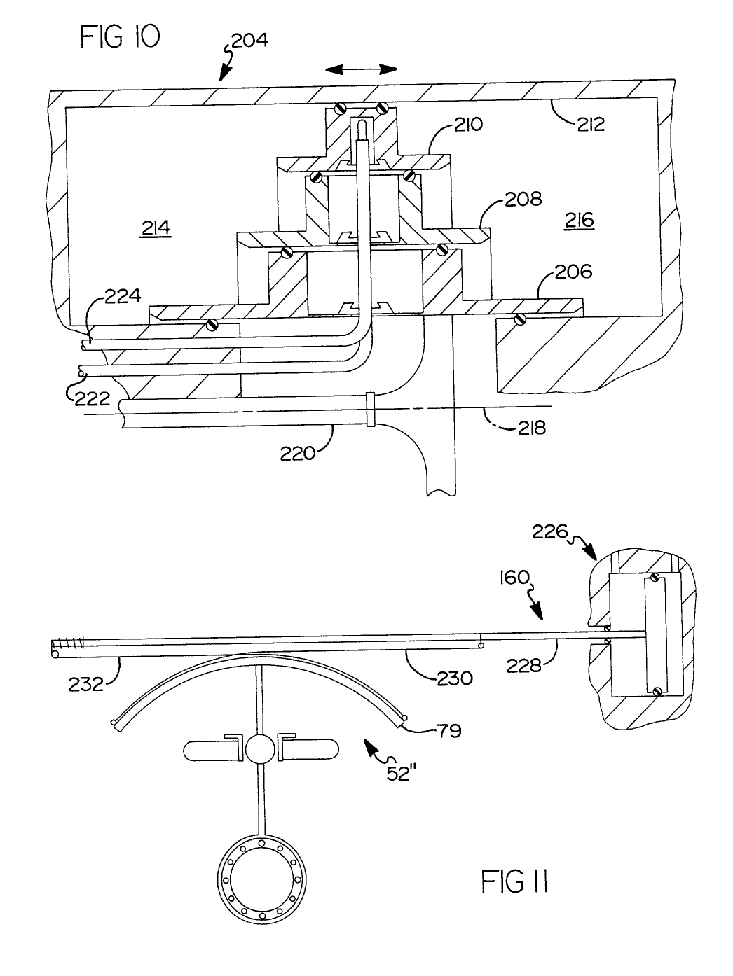

An alternative push-pull piston assembly 204 is shown in FIG. 10. The assembly 204 includes three annular nested pistons 206, 208 and 210. The piston 206 is the radially innermost piston and the piston 210 is the radially outermost piston. The pistons 206, 208 and 210 are disposed in a sealed annular cavity 212 and cooperate therewith to form hydraulic chambers 214, 216. The cavity 212 and the pistons 206, 208 and 210 have a common centerline 218. The pistons 206, 208 and 210 have respective output members 220, 222 and 224 that are connected with respective trunnion assemblies 52, 52A and 52B. The areas presented by the pistons 206, 208 and 210 to the chambers 214 and 216 are identical.

The trunnion control mechanism 160, represented schematically in FIG. 11, includes a push-pull piston assembly 226 that has an output member 228 which is connected with a flexible strap or cable 230 that is connected with a trunnion assembly 52″. A strap 232 is connected between the trunnion assembly 52″ and the output member 228 through a spring 234. The spring 234 has a preload greater than the maximum force applied hydraulically to the piston assembly 226. The spring 234 insures that no slack is present in the system. When the pressure is increased on the right side of the piston assembly 160, the strap 232 will enforce rotary motion of the trunnion assembly 52″ and when the left side of the piston assembly 160 is pressurized, the strap 230 will enforce rotary motion of the trunnion assembly 52″.

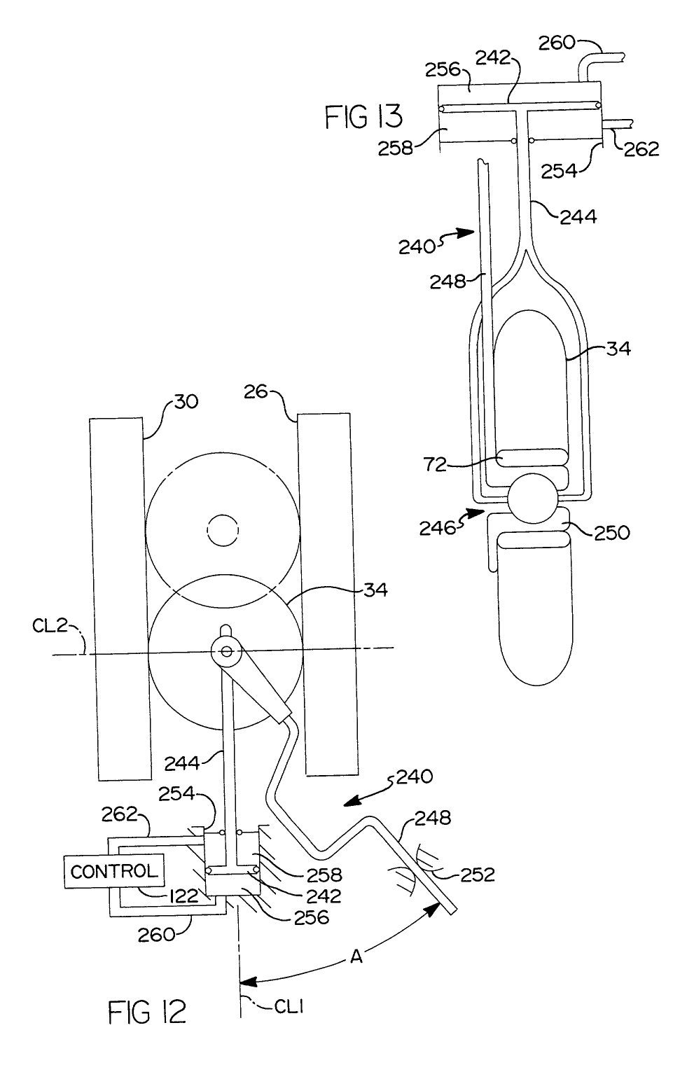

Another alternative embodiment of the present invention is shown in FIGS. 12 and 13. A trunnion assembly 240 includes a piston 242 and rod 244 that acts directly on a spherical bearing 246. A caster angle control rod 248 has formed thereon a housing 250 of the spherical bearing 246. The control rod 248 is guided at a pivot point 252 to establish the caster angle A between the control rod 248 and the centerline CL1. The piston 242 is slidably disposed in a cavity 254 and cooperates therewith to form a pair of chambers 256 and 258 that are in communication with the control 122 through passages 260 and 262, respectively. The chambers 256 and 258 are pressurized by the control 122 to urge the roller 34 off of the centerline CL2 as viewed in FIG. 12. This action causes the roller to steer to change the ratio of the CVU 20. The caster angle A maintains the stability of the rollers 34 during the steering operation. The trunnion control force is substantially perpendicular to the centerline CL2, but does not prevent the imposition of radial forces from the trunnion control piston 242. As with the embodiments shown in FIGS. 2, 3, and 4, this embodiment also separates the line of action imposed by the trunnion control from the caster angle alignment.

1. A continuously variable ratio transmission comprising:
a full toroidal continuously variable unit having a torus cavity formed between an input and an output member, a traction roller positioned in said torus cavity and being in traction drive contact with both said input member and said output member;
a traction roller positioning mechanism having a line of action substantially within a central plane of said torus cavity;
means for moving at least a portion of said roller positioning mechanism along said line of action;
a caster angle control mechanism including a rod having an angular position greater than 20 degrees relative to a centerline of said traction roller in said central plane;
a spherical bearing having a housing operatively connected with said rod and a sphere operatively connected with said traction roller positioning mechanism; and
a bearing rotatably supporting said traction roller on said housing.

2. The continuously variable ratio transmission defined in claim 1 further comprising:
said traction positioning mechanism including a radial support member supporting said sphere of said spherical bearing and being operatively connected with said moving means, and a hub portion on said radial support member being supported on a central support structure; and
said caster angle control mechanism including a grounding member operatively connected with said rod member to maintain said angular position of said rod member when said radial support member is moved by said moving means.

3. The continuously variable ratio transmission defined in claim 2 further comprising:
said continuously variable unit including three each of said traction rollers, said traction positioning mechanism, and said castor angle control mechanism; and
said moving means including a hydraulically-operated motor comprised of piston means having an output rod member drivingly connected with each of said traction positioning mechanisms to provide a force acting along said line of action.

4. The continuously variable ratio transmission defined in claim 3 further comprising:
said piston means having three nested pistons disposed in a single cavity, each piston having an output member;
each of said traction positioning mechanisms having an shoe integral with said radial support member; and
means for connecting each piston with respective ones of said shoes.

5. The continuously variable ratio transmission defined in claim 2 further comprising:
said continuously variable unit including three each of said traction rollers, said traction positioning mechanism, and said castor angle control mechanism, each said traction positioning mechanism having a shoe integral with said radial support member;
said moving means including first and second hydraulically-operated motors each comprised of three nested pistons disposed in a single cavity and each having an output rod; and
first and second strap members operatively connected with each of said shoes and said first strap members being drivingly connected with respective ones of said pistons of said first hydraulically-operated motor and said second strap members being drivingly connected with respective ones of said pistons of said second hydraulically-operated motor.
